(19) United States
(12) Patent Application Publication
(10) Pub. No.: US 2018/0142863 A1
(43) Pub. Date: May 24, 2018

(54) LIGHT FIXTURE HAVING VARIABLE SHAPE LAMPSHADE

(71) Applicant: I2M CO., LTD., Daejeon (KR)

(72) Inventor: Dong Yeon CHO, Daejeon (KR)

(73) Assignee: I2M CO., LTD., Daejeon (KR)

(21) Appl. No.: 15/314,510

(22) PCT Filed: Nov. 22, 2016
(86) PCT No.: PCT/KR2016/013463

§ 371 Date: Nov. 29, 2016

(30) Foreign Application Priority Data
Apr. 11, 2016 (KR) 10-2016-0044329
Nov. 16, 2016 (KR) 10-2016-0152334

(51) Int. Cl. F21V 1/08; F21V 3/02

(52) U.S. Cl. CPC F21V 1/08; F21V 3/023

(57) ABSTRACT

Disclosed is a light fixture having a variable shape lampshade comprising: a socket including a light bulb emitting light by using electricity supplied from an outside; a main bracket to which the socket is fixed; a support bracket coupled to a side surface of the main bracket; a variable link unit having a plurality of links and being coupled to the support bracket, the variable link unit being extended or shortened by changing angles formed by the plurality of links coupled to each other; a drive unit providing power to a first side of the variable link unit by using electricity supplied from a circuit board installed inside the light bulb; and a lampshade of which a first side is fixed to the main bracket and a second side is connected to a second side of the variable link unit.

### TECHNICAL FIELD

The present invention relates generally to a light fixture having a variable shape lampshade capable of changing a shape of the lampshade as desired. More particularly, the present invention relates to a light fixture having a variable shape lampshade in which various shapes of the lampshade can be realized, and the lampshade can be easily detachable, thereby reducing replacement costs when the lampshade is damaged. Furthermore, a shape of the lampshade can be controlled by using an external device, such as a terminal.

### BACKGROUND ART

In general, a lampshade protects a lamp and prevents a lamp from being damaged by a direct impact. A lampshade gathers or disperses light from a lamp so as to make a softly lit atmosphere. Furthermore, a lampshade is utilized for interior design purposes by decorating the appearance of a light fixture.

This lampshade according to the related art is fixed to a ceiling by using a flange provided on an upper portion of the lampshade. The lampshade is made of cloth, glass, or a synthetic resin material such as acrylic by being manufactured by extrusion molding or injection molding. Thus, the lampshade is coupled to a light fixture.

The lampshade manufactured by the above-described method is usually aesthetic. However, since a shape of the lampshade is fixed, the lampshade becomes outdated after using the lampshade for a predetermined period.

As described, since a size and a shape of the lampshade coupled to a light fixture according to the related art are fixed, it is impossible for a user to adjust the lampshade to variously change the atmosphere of a room, and is difficult to repair and replace the lampshade when the lampshade is damaged.

Accordingly, a light fixture having a variable shape lampshade is required so as to provide a user with a dynamic room atmosphere and provide aesthetic pleasure by allowing the user to variously change a shape of the lampshade.

### DISCLOSURE

### Technical Problem

Accordingly, the present invention has been made keeping in mind the above problems occurring in the related art, and the present invention is intended to propose a light fixture having a variable shape lampshade with improved decoration characteristics whereby the light fixture is capable of variously changing a shape of the lampshade by manufacturing the lampshade with a soft material made of plastic or non-woven fabric.

### Technical Solution

In order to achieve the above object, according to one aspect of the present invention, there is provided a light fixture having a variable shape lampshade, the light fixture including: a socket 100 including a light bulb 110, the light bulb 110 emitting light by using electricity supplied from an outside; a main bracket 200 to which the socket 100 is fixed; a support bracket 300 coupled to a side surface of the main bracket 200; a variable link unit 400 having a plurality of links and being coupled to the support bracket 300, the variable link unit 400 being extended or shortened by changing angles formed by the plurality of links coupled to each other; a drive unit 500, 900 providing power to a first side of the variable link unit 400 by using electricity supplied from a circuit board installed inside the light bulb 110; and a lampshade 600 of which a first side is fixed to the main bracket 200 and a second side is connected to a second side of the variable link unit 400 so as to change a shape of the lampshade 600 depending on extending or shortening the variable link unit 400.

The support bracket 300 may include: a guide groove unit 310 that couples the support bracket 300 and the variable link unit 400 to each other, in which the guide groove unit 310 includes: a first guide groove 311 formed in an upper portion of the support bracket 300; and a second guide groove 312 formed symmetrically to the first guide groove 311, and the variable link unit 400 includes: a first link 410 of which a first end is connected to the first guide groove 311; a second link 420 of which a first end is connected to the second guide groove 312, the second link 420 symmetrically intersecting the first link 410 so as to rotate based on an intersecting point of the first and second links 410 and 420; and a rotation pin unit 430 coupling the first and second links 410 and 420 at the intersecting point.

The variable link unit 400 may include: a first-second link 412 of which a first end is connected to a second end of the first link 410; a first-third link 413 of which a first end is connected to a second end of the first-second link 412; a second-second link 422 of which a first end is connected to a second end of the second link 420; and a second-third link 423 of which a first end is connected to a second end of the second-second link 422, and the rotation pin unit 430 may include first, second, and third rotation pins 431, 432, and 433 coupling the first link 410, the first-second link 412, and the first-third link 413 to the second link 420, the second-second link 422, and the second-third link 423 at respective intersecting points, so that the first link 410, the first-second link 412, and the first-third link 413 rotatably intersect the second link 420, the second-second link 422, and the second-third link 423, respectively, in which when the variable link unit 400 is extended or shortened, an edge of the variable link unit 400 may be formed in a curved shape because a distance D1 between a coupling point P1, at which the first link 410 and the first-second link 412 are coupled to each other, and the first rotation pin 431 and a distance D1 between the coupling point P1 and the second rotation pin 432 are different from a distance D2 between a coupling point P2, at which the first-second link 412 and the first-third link 413 are coupled to each other, and the second rotation pin 432 and a distance D2 between the coupling point P2 and the third rotation pin 433, and a distance D3 between a coupling point P3, at which the second link 420 and the second-second link 422 are coupled to each other, and the first rotation pin 431 and a distance D3 between the coupling point P3 and the second rotation pin 432 are different from a distance D4 between a coupling point P4, at which the second-second link 422 and the second-third link 423 are coupled to each other, and the second rotation pin 432 and a distance D4 between the coupling point P4 and the third rotation pin 433.

The drive unit 500 may include: a drive motor 510 operated by using electricity supplied from the light bulb 110; a first gear 520 rotating by a rotational force transmitted from the drive motor 510; a second gear 530 rotating by meshing with the first gear 520; and a rod 540 of which a first end is coupled to the rotation pin unit 430 and a second end is coupled to the second gear 530, in which the rod 540 may operate the variable link unit 400 by rotation of the second gear 530 so that the first ends of the first and second links 410 and 420 perform reciprocating movement along the first and second guide grooves 311 and 312, respectively.

The light fixture may further include a support unit 700 supporting the variable link unit 400 so as to prevent the variable link unit 400 from sagging, the support unit 700 including: a support rod 710 of which an end is connected to the variable link unit 400, the support rod 710 sliding on the support bracket 300 depending on extending or shortening the variable link unit 400, with a plurality of grooves 711 formed on a side surface of the support rod 710; a pressure bar 720 of which an end is seated on the plurality of grooves 711; and an elastic member 730 elastically supporting the pressure bar 720 so that the support rod 710 supports the variable link unit 400. Furthermore, the light fixture may further include: a lampshade connector 800 of which a first end is rotatably coupled to the variable link unit 400 and a second end is connected to an inner side surface of the lampshade 600, the lampshade connector 800 moving the lampshade 600 along an extending or shortening direction of the variable link unit 400 when the variable link unit 400 is extended or shortened.

The drive unit 900 may include: an auxiliary bracket 910 coupled to the support bracket 300, the auxiliary bracket 910 including: an upper plate 911 provided on an upper end of the auxiliary bracket 910; a lower plate 912 provided on a lower end of the auxiliary bracket 910; and a side plate 913 connecting the upper and lower plates 911 and 912 to each other; a rotary shaft 920 rotatably coupled to the upper and lower plates 911 and 912; and a drive motor 930 coupled to an end of the rotary shaft 920, the drive motor 930 rotating the rotary shaft 920.

The drive unit 900 may include: a first body 940 of which a side is coupled to one of the plurality of links, the first body 940 being fitted over the rotary shaft 920 so as to vertically move by rotation of the rotary shaft 920; and a second body 950 of which a side is coupled to another one of the plurality of links, the second body 950 being fitted over the rotary shaft 920 so as to vertically move by rotation of the rotary shaft 920, in which directions of threads formed in the first body 940 are different from directions of threads formed in the second body 950.

### Advantageous Effects

According to the present invention, it is advantageous as follows. A pair of variable link units of a light fixture having a variable shape lampshade is spread in left and right directions by external power supply, and can be changed as various shapes. Furthermore, a shape of the lampshade covering outsides of the variable link units can be changed depending on the variable link units, and thus light direction of the lampshade can be refracted, thereby realizing various interior atmospheres.

### DESCRIPTION OF DRAWINGS

FIG. 1 is a perspective view illustrating an overall appearance of a light fixture having a variable shape lampshade according to the present invention;

FIG. 2 is a perspective view illustrating a main configuration provided in a lampshade of the light fixture according to the present invention;

FIG. 3 is a side view illustrating an operation method of a variable link unit of the light fixture according to the present invention;

FIG. 4 is a perspective view illustrating a state where a length of the lampshade is changed depending on a change in the variable link unit of the light fixture according to the present invention;

FIG. 5 is a side view illustrating an embodiment of the variable link unit of the light fixture according to the present invention;

FIG. 6 is a perspective view illustrating a main configuration of a drive unit of the light fixture according to the present invention;

FIG. 7 is a perspective view illustrating a main configuration of a support unit of the light fixture according to the present invention;

FIG. 8 is a sectional view illustrating a coupling structure of a lampshade connector and the lampshade of the light fixture according to the present invention; and

FIG. 9 is a perspective view illustrating a main configuration of another drive unit of the light fixture according to the present invention.

### BEST MODE

Reference will now be made in greater detail to an exemplary embodiment of the present invention, an example of which is illustrated in the accompanying drawings.

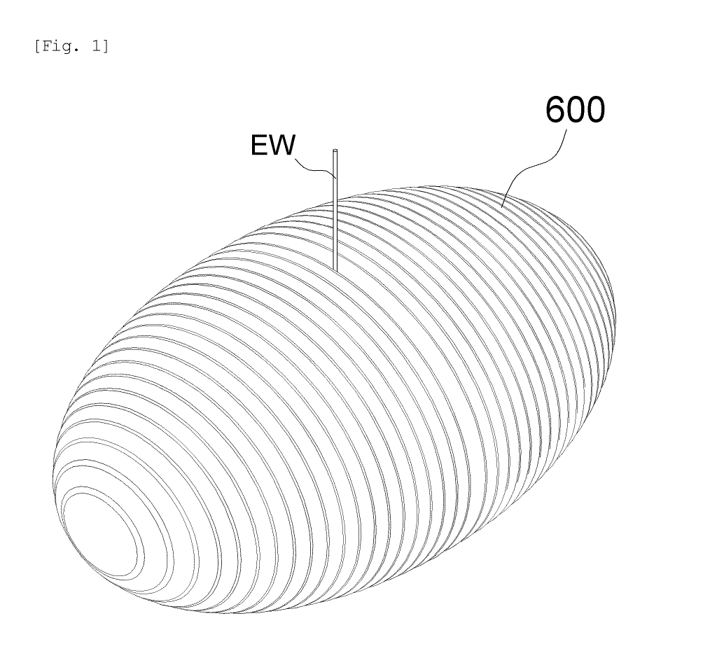

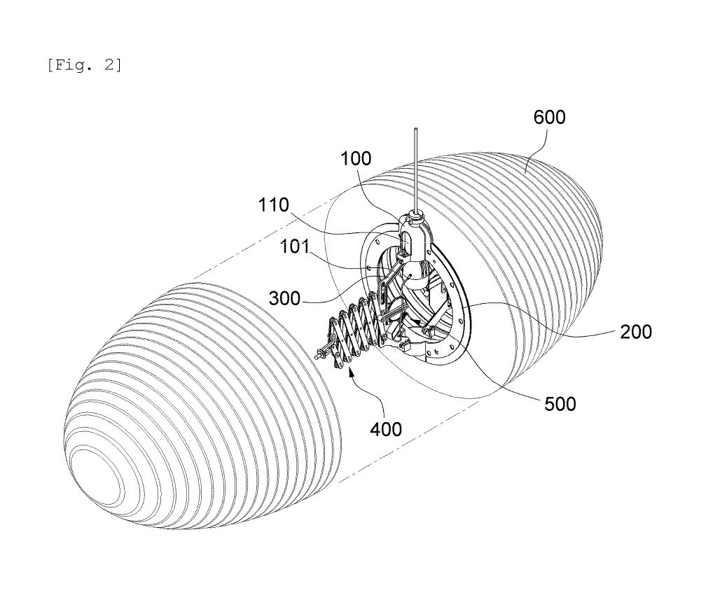

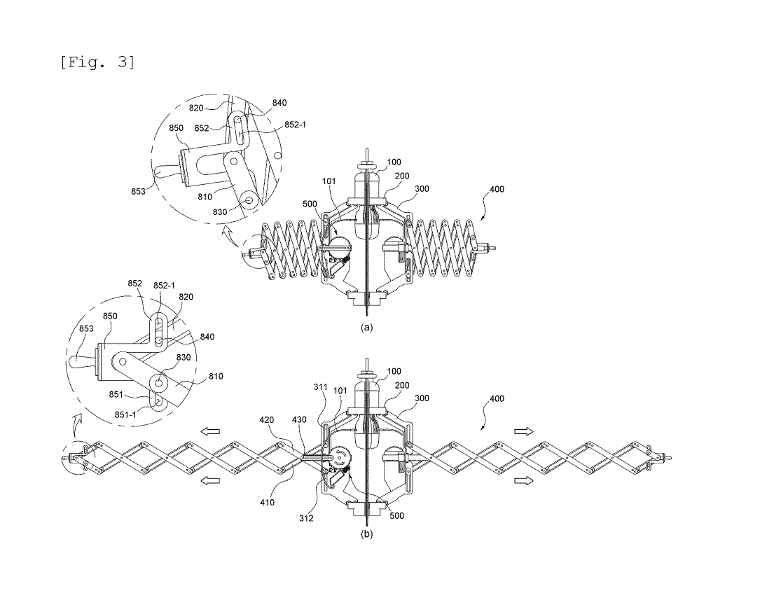

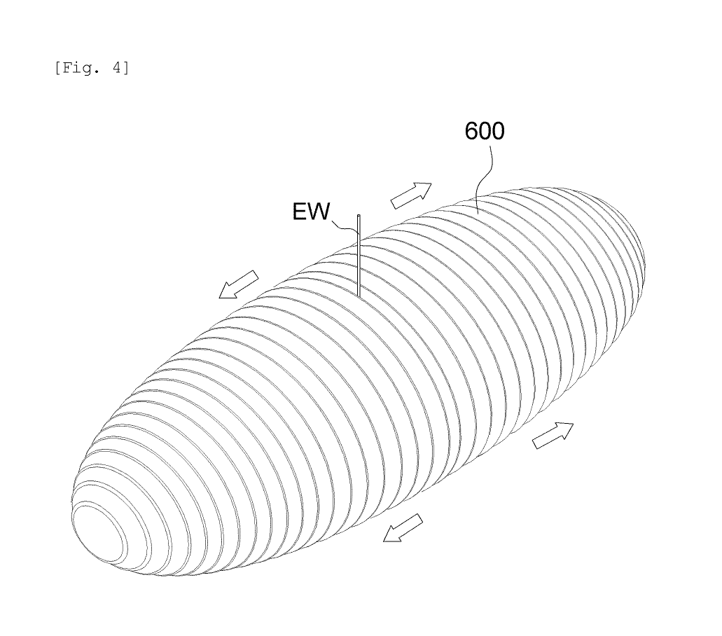

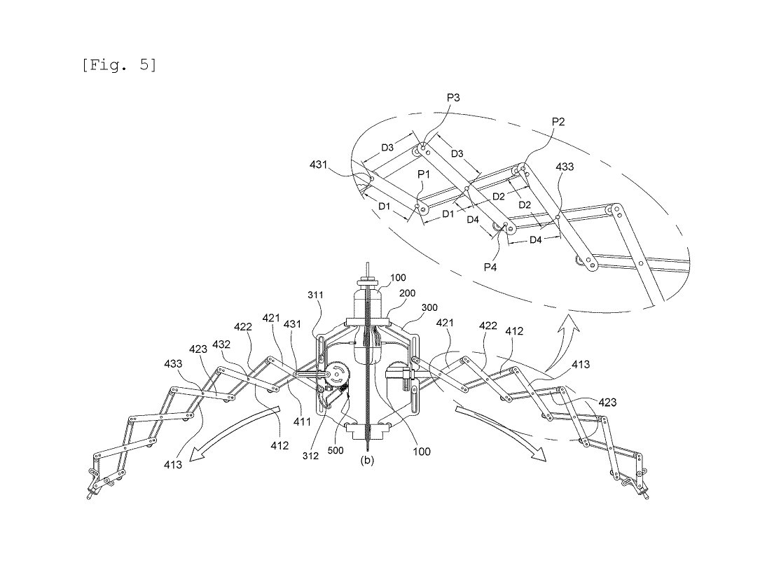

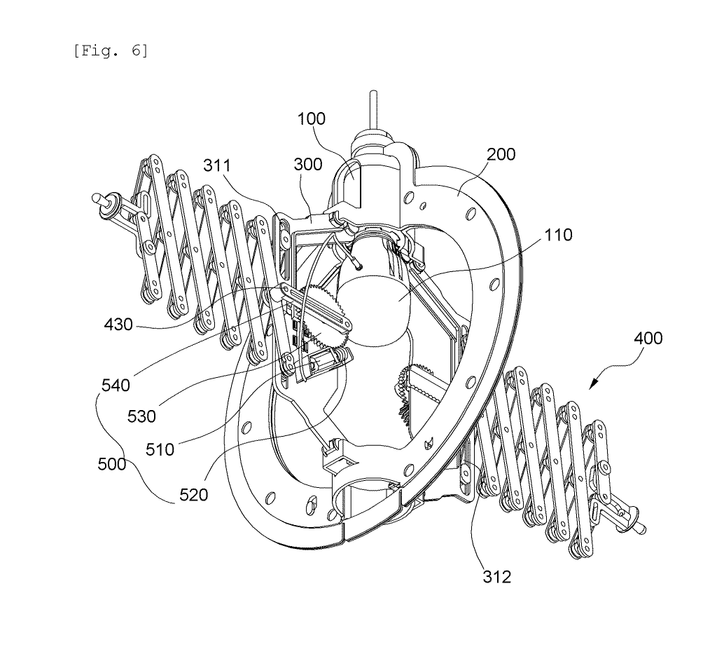

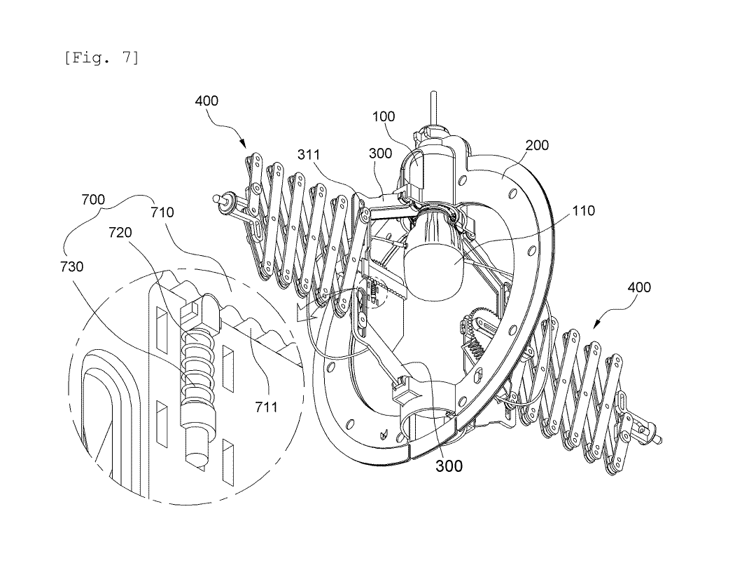

FIG. 1 is a perspective view illustrating an overall appearance of a light fixture having a variable shape lampshade according to the present invention, FIG. 2 is a perspective view illustrating a main configuration provided in a lampshade of the light fixture according to the present invention, FIG. 3 is a side view illustrating an operation method of a variable link unit of the light fixture according to the present invention, FIG. 4 is a perspective view illustrating a state where a length of the lampshade is changed depending on a change in the variable link unit of the light fixture according to the present invention, FIG. 5 is a side view illustrating an embodiment of the variable link unit of the light fixture according to the present invention, FIG. 6 is a perspective view illustrating a main configuration of a drive unit of the light fixture according to the present invention, and FIG. 7 is a perspective view illustrating a main configuration of a support unit of the light fixture according to the present invention.

Referring to FIGS. 1 and 2, the light fixture according to the present invention includes a socket 100. Further, an electric wire is connected to a side of the socket 100 so as to supply electricity from an outside to the socket 100. A light bulb 110 may be coupled to the socket 100. Any bulb, such as an incandescent bulb, a three wave length bulb, and an LED bulb, may be utilized as the light bulb 110 as long as the bulb uses a light emitting element with electricity supply. Furthermore, a smart bulb having an on/off function performed by communicating with an external device may be utilized as the light bulb 110.

Referring to FIGS. 2 and 3, a main bracket 200 supports the socket 100. The main bracket 200 surrounds an outer surface of the socket 100, and fixes the socket 100 thereto. A support bracket 300 is coupled to a side surface of the main bracket 200. The support bracket 300 may be symmetrically provided on opposite sides of the main bracket 200. The support bracket 300 may extend from the side surface of the main bracket 200. Guide grooves 311 and 312 formed in an elongated hole shape are formed in upper and lower directions along a longitudinal direction of the support bracket 300.

Referring to FIG. 2, a first end of the variable link unit 400 is coupled to the guide grooves 311 and 312 of the support bracket 300. The variable link unit 400 has a scissor lift structure in which a plurality of links 410 and 420 is coupled to each other. Angles formed by coupling the plurality of links 410 and 420 to each other may be changed by a drive unit 500. Particularly, the first end of the variable link unit 400 coupled to the guide grooves 311 and 312 moves along the guide grooves 311 and 312, and the plurality of links 410 and 420 of the variable link unit 400 is folded or spread. Accordingly, a length of the variable link unit 400 is changed.

Referring to FIG. 2, the drive unit 500 is connected to the variable link unit 400, and controls operation of the variable link unit 400. The drive unit 500 may be operated by using electricity supplied from an electric wire EW connected to the light bulb 110, or from the light bulb 110.

When the drive unit 500 uses electricity supplied from the light bulb 110, the drive unit 500 and the light bulb 110 may be connected to each other by using a separate connection cable 101. A first end of the connection cable 101 is connected to a circuit board (not shown) installed inside the light bulb 110, and a second end of the connection cable 101 is connected to the drive unit 500 so that part of electricity supplied to the light bulb 110 is supplied to the drive unit 500. In this case, when a smart bulb is utilized as the light bulb 110, the light bulb 110 may be operated in conjunction with various terminals (not shown). Further, brightness of the light bulb 110 or electricity supplied to the drive unit 500 may be controlled by manipulation of a terminal user. The user may control the drive unit 500 by using an application program (hereinafter referred to as app) of a terminal or a remote controller.

Referring to FIGS. 1 and 2, a lampshade 600 covers the socket 100, the main bracket 200, the support bracket 300, and the variable link unit 400.

A first side of the lampshade 600 is fixed to the main bracket 200, and a second side of the lampshade 600 is connected to a second end of the variable link unit 400. Thus, an outer shape of the lampshade 600 is changed depending on extending or shortening the variable link unit 400. In this regard, the lampshade 600 may be formed in a corrugated shape.

Referring to FIG. 3, the guide grooves 311 and 312 includes the first guide groove 311 and the second guide groove 312. Preferably, the first guide groove 311 is formed in an upper portion of the support bracket 300, and the second guide groove 312 is formed in a lower portion of the support bracket 300 such that the second guide groove 312 is symmetrical to the first guide groove 311.

The variable link unit 400 comprises the plurality of links that are coupled to each other. Particularly, the variable link unit 400 includes a first link 410 of which a first end is connected to the first guide groove 311, and a second link 420 of which a first end is connected to the second guide groove 312. The first and second links 410 and 420 have predetermined thicknesses and lengths. The first and second links 410 and 420 are coupled to each other in a state of being intersected with each other. In this case, the first and second links 410 and 420 may freely rotate based on an intersecting point of the first and second links 410 and 420. A rotation pin unit 430 couples the first and second links 410 and 420 to each other at the intersecting point of the first and second links 410 and 420. The first and second links 410 and 420 may stably rotate by using the rotation pin unit 430.

Referring to FIG. 3, when the first ends of the first and second links 410 and 420 are located in an upper portion of the first guide groove 311 and a lower portion of the second guide groove 312, respectively, a length of the variable link unit 400 is shortened. On the contrary, when the first ends of the first and second links 410 and 420 are located in a lower portion of the first guide groove 311 and an upper portion of the second guide groove 312, respectively, the length of the variable link unit 400 is extended. Thus, a shape of the lampshade 600 may be changed.

Referring to FIGS. 3 and 5, the plurality of links may include the first and second links 410 and 420. Further, the plurality of links may include plural links, such as a first-first link 411, a first-second link 412, a first-third link 413, and a first-n link. Likewise, the plurality of links may include plural links, such as a second-first link 421, a second-second link 422, a second-third link 423, and a second-n link. In this regard, as shown in FIGS. 3 and 5, the above-described links are coupled to each other, and angles formed by the above-described links coupled to each other may be freely changed.

Referring to FIGS. 3 and 5, the rotation pin unit 430 includes: a first rotation pin 431 coupling the first-first link 411 to the second-first link 421; a second rotation pin 432 coupling the first-second link 412 to the second-second link 422; and a third rotation pin 433 coupling the first-third link 413 to the second-third link 423, at respective intersecting points.

Referring to FIG. 5, an embodiment of the variable link unit 400 will be described.

A distance between a coupling point P1, at which the first-first link 411 and the first-second link 412 are coupled to each other, and the first rotation pin 431 is regarded as a distance D1, and another distance between the coupling point P1 and the second rotation pin 432 is regarded as another distance D1. Furthermore, a distance between a coupling point P2, at which the first-second link 412 and the first-third link 413 are coupled to each other, and the second rotation pin 432 is regarded as a distance D2, and another distance between the coupling point P2 and the third rotation pin 433 is regarded as another distance D2. In this case, the first-first link 411 and the first-second link 412 may be coupled to each other and the first-second link 412 and the first-third link 413 may be coupled to each other so that the distances D1 may be longer than, or may be shorter than the distances D2.

A distance between a coupling point P3, at which the second-first link 421 and the second-second link 422 are coupled to each other, and the first rotation pin 431 is regarded as a distance D3, and another distance between the coupling point P3 and the second rotation pin 432 is regarded as another distance D3. Furthermore, a distance between a coupling point P4, at which the second-second link 422 and the second-third link 423 are coupled to each other, and the second rotation pin 432 is regarded as a distance D4, and another distance between the coupling point P4 and the third rotation pin 433 is regarded as another distance D4. In this case, the second-first link 421 and the second-second link 422 may be coupled to each other and the second-second link 422 and the second-third link 423 may be coupled to each other so that the distances D3 may be longer than, or may be shorter than the distances D4.

When the drive unit 500 is operated, an edge of the variable link unit 400 is extended or shortened in a state of being formed in a curved shape due to distance difference between the distances D1 and D2, and distance difference between the distances D3 and D4. Thus, the shape of the lampshade 600 may be dynamically changed, thereby providing aesthetic pleasure to a user.

Referring to FIG. 6, the drive unit 500 includes a drive motor 510, a first gear 520, a second gear 530, and a rod 540. The drive motor 510 is operated by using electricity supplied from the socket 100. The electricity is supplied from the socket 100 to the drive motor 510 by using the connection cable 101.

The first gear 520 is connected to the drive motor 510, and rotates by power transmitted from the drive motor 510. The first gear 520 may be a worm gear. However, the first gear 520 is not limited to the worm gear, and various gears may be utilized as the first gear 520.

The second gear 530 rotates by rotational force transmitted from the first gear 520 by meshing with the first gear 520. The second gear 530 is formed in a disk shape having a predetermined thickness, and a plurality of gear teeth is formed on an outer circumferential surface of the second gear 530. In this case, a direction of a rotary shaft of the second gear 530 may perpendicularly intersect an extending or shortening direction of the variable link unit 400.

Furthermore, the rod 540 is formed in a bar or board shape having a predetermined thickness, and a first end of the rod 540 is coupled to the rotation pin unit 430. Preferably, the first end of the rod 540 is coupled to the first rotation pin 431. Further, a second end of the rod 540 is coupled to an outer edge of the second gear 530 so that the rod 540 moves forward and backward depending on rotation directions of the second gear 530.

Accordingly, when the second gear 530 rotates, the rod 540 connected to the second gear 530 is operated, and thus the variable link unit 400 may be extended or shortened. That is, when the rod 540 pushes the rotation pin unit 430 toward an outer side of the main bracket 200, the first ends of the first and second links 410 and 420 move along the first and second guide grooves 311 and 312, respectively, and the first and second links 410 and 420 are spread. On the contrary, when the rod 540 pulls the rotation pin unit 430 toward an inner side of the main bracket 200, the first ends of the first and second links 410 and 420 move along the respective first and second guide grooves 311 and 312, and the first and second links 410 and 420 are folded. While the second gear 530 continuously rotates, the variable link unit 400 may be repeatedly extended or shortened.

Referring to FIG. 7, a support unit 700 is provided so as to prevent the variable link unit 400 from sagging. In addition, the support unit 700 may guide the rod 540 so that the rod 540 may move to a predetermined direction.

The support unit 700 includes a support rod 710, and the support rod 710 is coupled to the support bracket 300 such that the support rod 710 may slide on the support bracket 300. The support rod 710 moves by sliding on the support bracket 300 depending on extending or shortening the variable link unit 400. An end of the support rod 710 is connected to the rotation pin unit 430. Preferably, the end of the support rod 710 is connected to the first rotation pin 431. The extending or shortening direction of the variable link unit 400 may be guided by sliding directions of the support rod 710. Furthermore, the variable link unit 400 may be prevented from sagging in such a way that the support rod 710 is coupled to the support bracket 300. A plurality of grooves 711 may be formed on a side surface of the support rod 710, and the plurality of grooves 711 is depressed toward an inner side of the support rod 710.

The support unit 700 includes a pressure bar 720, and an elastic member 730. An end of the pressure bar 720 is inserted into any one of the plurality of grooves 711 of the support rod 710. Each of portions between the plurality of grooves 711 is formed in a curved shape having a predetermined radius of curvature. Thus, when the support rod 710 slides on the support bracket 300, the end of the pressure bar 720 may move from one of the plurality of grooves 711 to another neighboring one of the plurality of grooves 711.

The elastic member 730 is provided at a lower end of the pressure bar 720 so as to elastically support the pressure bar 720 in an upward direction. The pressure bar 720 may support the variable link unit 400 by upwardly pressing the support rod 710. In this case, since the pressure bar 720 is elastically supported in a state of being inserted into one of the plurality of grooves 711, the variable link unit 400 may be prevented from being bent due to its own weight.

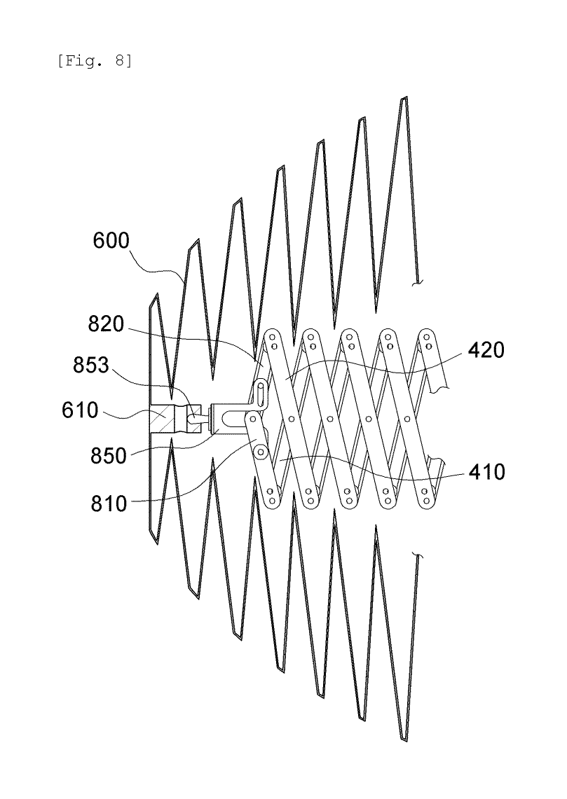

Referring to FIGS. 3 and 8, a lampshade connector 800 is coupled to a distal end of the variable link unit 400. The lampshade connector 800 moves the lampshade 600 depending on extending or shortening the variable link unit 400.

Referring to an enlarged view in FIG. 3, the lampshade connector 800 includes: a first connection link 810 rotatably coupled to a distal end of the first link 410, and a second connection link 820 rotatably coupled to a distal end of the second link 420. Ends of the first and second connection links 810 and 820, which are not coupled to the first and second links 410 and 420, are rotatably coupled to each other. Furthermore, first and second sliding pins 830 and 840 protrude from side surfaces of the first and second connection links 810 and 820, respectively.

Referring to FIG. 3, the lampshade connector 800 includes a connection body 850 located at the ends of the first and second connection links 810 and 820. A first guide rod 851 having a first elongated hole 851-1 into which the first sliding pin 830 is inserted, and a second guide rod 852 having a second elongated hole 852-1 into which the second sliding pin 840 is inserted are provided on the connection body 850. In this case, the first and second elongated holes 851-1 and 852-1 may be formed by being elongated by predetermined lengths. Further, when the first and second links 410 and 420 are folded, the first and second sliding pins 830 and 840 are guided to the first and second elongated holes 851-1 and 852-1, and slide on the first and second elongated holes 851-1 and 852-1, respectively.

Referring to FIGS. 3 and 8, a coupling protrusion 853 coupled to a coupling link 610 protruding from an inner side of the lampshade 600 is formed on the connection body 850. By means of this, the first and second links 410 and 420 are folded depending on extending or shortening the variable link unit 400. In this case, the first and second sliding pins 830 and 840 are guided to the first and second elongated holes 851-1 and 852-1, and slide on the first and second elongated holes 851-1 and 852-1, respectively. Thus, a moving direction of the coupling protrusion 853 may be the same as the extending or shortening direction of the variable link unit 400.

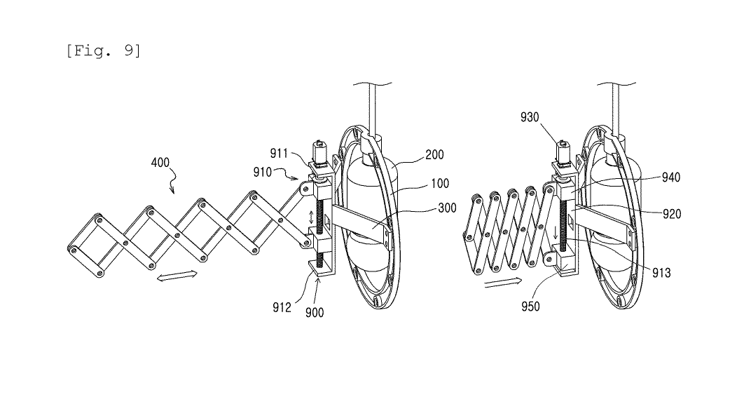

Referring to FIG. 9, another drive unit 900 of the present invention will be described. The drive unit 900 is described so as to efficiently operate the variable link unit 400. In this regard, since the curve-shaped movement of the variable link unit 400 depending on distance differences between the plurality of links, the lampshade connector 800 coupled to the distal end of the variable link unit 400, and a technology in which the drive unit uses electricity supplied from the circuit board of the socket 100, which are described above, may be applied in the same way. Accordingly, detailed descriptions thereof will be omitted.

Referring to FIG. 9, a support bracket 300 is coupled to a side of a main bracket 200. The drive unit 900 operating a variable link unit 400 is coupled to the support bracket 300. The drive unit 900 includes an auxiliary bracket 910, a rotary shaft 920, a drive motor 930, a first body 940, and a second body 950.

The auxiliary bracket 910 may include: an upper plate 911 coupled to a first end of the rotary shaft 920; a lower plate 912 coupled to a second end of the rotary shaft 920; and a side plate 913 connecting the upper and lower plates 911 and 912 to each other, and being coupled to the support bracket 300. The drive motor 930 rotating the rotary shaft 920 is provided at a side of any one of the upper and lower plates 911 and 912.

The first and second ends of the rotary shaft 920 are coupled to the upper and lower plates 911 and 912, respectively, and the rotary shaft 920 rotates. Threads are formed on an outer circumferential surface of the rotary shaft 920. The first and second bodies 940 and 950 are fitted over the rotary shaft 920. Threads are formed on inner surfaces of the first and second bodies 940 and 950 so that the threads of the first and second bodies 940 and 950 mesh with the threads of the rotary shaft 920. The first and second bodies 940 and 950 are lifted and are lowered along a longitudinal direction of the rotary shaft 920 depending on rotation of the rotary shaft 920. Directions of the threads formed in the first body 940 may be opposite to directions of the threads formed in the second body 950 so that the first and second bodies 940 and 950 are lifted and are lowered oppositely to each other. Accordingly, the threads of the rotary shaft 920 may be formed correspondingly to the threads of the first and second bodies 940 and 950. Meanwhile, the first and second bodies 940 and 950 are coupled to an end of the variable link unit 400.

The first and second bodies 940 and 950 are lifted and are lowered depending on rotation of the drive motor 930. A length of the variable link unit 400 is changed depending on distance difference between the first and second bodies 940 and 950.

As described, according to the light fixture of the present invention, it is advantageous in that since a pair of the variable link units 400 spread in left and right directions can be changed as various shapes, a shape of the lampshade 600 covering outsides of the variable link units 400 can be also changed, and light direction of the lampshade can be refracted, thereby realizing various interior atmospheres.

### INDUSTRIAL APPLICABILITY

The present invention relates to a light fixture having a variable shape lampshade capable of changing a shape of the lampshade as desired. In the light fixture of the present invention, various shapes of the lampshade can be realized, and a structure of the lampshade is simplified so as to be easily detachable. Thus, replacement costs can be reduced when the lampshade is damaged. In addition, a shape of the lampshade can be freely controlled by using an external terminal.

1. A light fixture having a variable shape lampshade, the light fixture comprising:
a socket (100) including a light bulb (110), the light bulb (110) emitting light by using electricity supplied from an outside;
a main bracket (200) to which the socket (100) is fixed;
a support bracket (300) coupled to a side surface of the main bracket (200);
a variable link unit (400) having a plurality of links and being coupled to the support bracket (300), the variable link unit (400) being extended or shortened by changing angles formed by the plurality of links coupled to each other;
a drive unit (500, 900) providing power to a first side of the variable link unit (400) by using electricity supplied from a circuit board installed inside the light bulb (110); and
a lampshade (600) of which a first side is fixed to the main bracket (200) and a second side is connected to a second side of the variable link unit (400) so as to change a shape of the lampshade (600) depending on extending or shortening the variable link unit (400).

2. The light fixture of claim 1, wherein
the support bracket (300) includes:
a guide groove unit (310) that couples the support bracket (300) and the variable link unit (400) to each other, wherein
the guide groove unit (310) includes:
a first guide groove (311) formed in an upper portion of the support bracket (300); and
a second guide groove (312) formed symmetrically to the first guide groove (311), and
the variable link unit (400) includes:
a first link (410) of which a first end is connected to the first guide groove (311);
a second link (420) of which a first end is connected to the second guide groove (312), the second link (420) symmetrically intersecting the first link (410) so as to rotate based on an intersecting point of the first and second links (410 and 420); and
a rotation pin unit (430) coupling the first and second links (410 and 420) at the intersecting point.

3. The light fixture of claim 2, wherein
the variable link unit (400) includes:
a first-second link (412) of which a first end is connected to a second end of the first link (410);
a first-third link (413) of which a first end is connected to a second end of the first-second link (412);
a second-second link (422) of which a first end is connected to a second end of the second link (420); and
a second-third link (423) of which a first end is connected to a second end of the second-second link (422), and
the rotation pin unit (430) includes first, second, and third rotation pins (431, 432, and 433) coupling the first link (410), the first-second link (412), and the first-third link (413) to the second link (420), the second-second link (422), and the second-third link (423) at respective intersecting points, so that the first link (410), the first-second link (412), and the first-third link (413) rotatably intersect the second link (420), the second-second link (422), and the second-third link (423), respectively, wherein
when the variable link unit (400) is extended or shortened, an edge of the variable link unit (400) is formed in a curved shape because a distance (D1) between a coupling point (P1), at which the first link (410) and the first-second link (412) are coupled to each other, and the first rotation pin (431) and a distance (D1) between the coupling point (P1) and the second rotation pin (432) are different from a distance (D2) between a coupling point (P2), at which the first-second link (412) and the first-third link (413) are coupled to each other, and the second rotation pin (432) and a distance (D2) between the coupling point (P2) and the third rotation pin (433), and
a distance (D3) between a coupling point (P3), at which the second link (420) and the second-second link (422) are coupled to each other, and the first rotation pin (431) and a distance (D3) between the coupling point (P3) and the second rotation pin (432) are different from a distance (D4) between a coupling point (P4), at which the second-second link (422) and the second-third link (423) are coupled to each other, and the second rotation pin (432) and a distance (D4) between the coupling point (P4) and the third rotation pin (433).

4. The light fixture of claim 2, wherein
the drive unit (500) includes:
a drive motor (510) operated by using electricity supplied from the light bulb (110);
a first gear (520) rotating by a rotational force transmitted from the drive motor (510);
a second gear (530) rotating by meshing with the first gear (520); and
a rod (540) of which a first end is coupled to the rotation pin unit (430) and a second end is coupled to the second gear (530), wherein
the rod (540) operates the variable link unit (400) by rotation of the second gear (530) so that the first ends of the first and second links (410 and 420) perform reciprocating movement along the first and second guide grooves (311 and 312), respectively.

5. The light fixture of claim 4, wherein
a support unit (700) supporting the variable link unit (400) so as to prevent the variable link unit (400) from sagging is provided, the support unit (700) including:
a support rod (710) of which an end is connected to the variable link unit (400), the support rod (710) sliding on the support bracket (300) depending on extending or shortening the variable link unit (400), with a plurality of grooves (711) formed on a side surface of the support rod (710);
a pressure bar (720) of which an end is seated on the plurality of grooves (711); and
an elastic member (730) elastically supporting the pressure bar (720) so that the support rod (710) supports the variable link unit (400).

6. The light fixture of claim 1, further comprising:
a lampshade connector (800) of which a first end is rotatably coupled to the variable link unit (400) and a second end is connected to an inner side surface of the lampshade (600), the lampshade connector (800) moving the lampshade (600) along an extending or shortening direction of the variable link unit (400) when the variable link unit (400) is extended or shortened.

7. The light fixture of claim 1, wherein
the drive unit (900) includes:
an auxiliary bracket (910) coupled to the support bracket (300), the auxiliary bracket (910) including:
an upper plate (911) provided on an upper end of the auxiliary bracket (910);
a lower plate (912) provided on a lower end of the auxiliary bracket (910); and
a side plate (913) connecting the upper and lower plates (911 and 912) to each other;
a rotary shaft (920) rotatably coupled to the upper and lower plates (911 and 912); and
a drive motor (930) coupled to an end of the rotary shaft (920), the drive motor (930) rotating the rotary shaft (920).

8. The light fixture of claim 7, wherein
the drive unit (900) includes:
a first body (940) of which a side is coupled to one of the plurality of links, the first body (940) being fitted over the rotary shaft (920) so as to vertically move by rotation of the rotary shaft (920); and
a second body (950) of which a side is coupled to another one of the plurality of links, the second body (950) being fitted over the rotary shaft (920) so as to vertically move by rotation of the rotary shaft (920), wherein
directions of threads formed in the first body (940) are different from directions of threads famed in the second body (950).
